(19) United States
(12) Patent Application Publication
(10) Pub. No.: US 2017/0012426 A1
(43) Pub. Date: Jan. 12, 2017

(54) FEEDING DEVICE AND ELECTRICAL JUNCTION BOX

(71) Applicant: Yazaki Corporation, Tokyo (JP)

(72) Inventors: Koichi Uezono, Makinohara-shi (JP); Kousuke Kinoshita, Makinohara-shi (JP); Takafumi Toda, Makinohara-shi (JP)

(21) Appl. No.: 15/205,934

(22) Filed: Jul. 8, 2016

(30) Foreign Application Priority Data
Jul. 10, 2015 (JP) 2015-138815

(51) Int. Cl. H02J 1/08; H02G 15/10

(52) U.S. Cl. CPC H02J 1/08; H02G 15/10

(57) ABSTRACT

A power-supply unit and an electric junction b are provided. A branch circuit branches a supply route of a 52V-battery into a (n is an integer of 3 or more) branch routes. A merge circuit joins the n branch routes to one supply route. MOSFETs are arranged on the n branch routes respectively. A rated current of each of the MOSFET is equal to or larger than a rated current of loads (12V-load, 52V-load, ECU, and 12V-battery) which are supplied with electric power from the supply route divided by n−1 and less than the rated current divided by n−2.

### BACKGROUND OF THE INVENTION

Field of the Invention

The present invention relates to a feeding device and an electric junction box.

Description of the Related Art

In a vehicle, a feeding device for supplying power from a battery to a load is arranged. The feeding device is provided with a switch for turning ON/OFF the power supply to the load between the load and the battery. In such feeding device, even if electric components of the feeding device are broken, it is required that electric supply is stabilized so as to not stop electric supply to the load. For example, in the Patent Literature 1, a backup of a driver for controlling the switch is provided (see Patent Literature 1).

Further, in order to continue power supply to the load even if the switch is broken, a supply system as shown in FIG. 2 is provided. In FIG. 2, a feeding device 100 has a branch circuit 102 which branches a supply route L10 from a 52V-battery into two branch routes L201, L202, a merge circuit 103 which joins the two branch routes L201, L202 to one of a supply route L30, and relays R11, R12 arranged on the two branch circuits L201, L202.

Relay coils of the relays R11, R12 are connected to an ECU 104, and the relays R11, R12 is ON/OFF controlled by the ECU 104.

Thereafter, the supply route L30 is branched into a 52V-load supply route L401 and a 12V-load supply route L402. The 52V-load supply route L401 is connected to a 52V-load 105. The 12V-load supply route L402 is connected to a 12V-load 107, a 12V-battery 108, and the ECU 104. A DC/DC converter 106 is arranged on the 12V-load supply route 402, coverts 52V to 12V, and supplies it to the 12V-load 107, the 12V-battery 108 and the ECU 104.

According to the above feeding device, the relays R11, R12 connected in parallel are provided. Thereby, even if one of elements is broken, power supply continues, and the power supply can be stabilized. However, as the rated current of the relays R11, R12, at least the sum of the rated currents of the 52V-load 105 which is connected to the supply routes L10, L30, the 12V-load 107 which is connected to the supply routes L10, L30, the ECU 104 are required, respectively.

For example, when the sum of the rated currents of the 52V-load 105 and the 12V-load 107 is 120 A, at least 120 A or more is required as the rated current of the relays R11, R12, For this reason, specification of the relays R21, R22 which 120 A×2=240 A is able to flow in total is provided. Therefore, there is a problem that waste occurs.

Patent Literature 1: JP 2013-135274 A

### SUMMARY OF THE INVENTION

Thus, it is an object of the present invention to provide a feeding device and an electric junction box which can achieve redundancy of the power source, reduce a rated current of the switching unit, and decrease waste.

In order to solve the above issue, the present invention has configurations described below. That is, the present invention according to a first aspect is a feeding device for supplying power to a load including a branch circuit for branching a supply route of the power into n (n is an integer of 3 or more) branch routes; a merge circuit for joining n branch routes to one of the supply route; and a switching unit arranged on n branch routes respectively. A rated current of the switching unit is equal to or larger than a rated current of the load divided by n−1 and less than the rated current of the load divided by n−2, the load being supplied with electric power from the supply route.

In the present invention, the switching unit is configured of a semiconductor switch.

Further, the present invention is an electric junction box having the feeding device described above.

According to the first and third aspects of the present invention, the branch circuit branches the supply route of the power into n (n is an integer of 3 or more), and the switching unit is arranged on n branch routes respectively. The rated current of the switching unit is equal or larger than the rated current of the load divided by n−1 and less than the rated current of the load divided by n−2. Thereby, it is possible to supply electric power to the load even if one of n switching units is failed. Further, redundancy of the power source can be achieved and the rated current of the switching unit can be reduced. As a result, waste can be decreased.

According to the second aspect of the present invention, since the switching unit is configured of the semiconductor switch, it is possible to miniaturize it.

### BRIEF DESCRIPTION OF THE DRAWINGS

FIG. 1 is a circuit view showing a feeding device and an electric junction box according to one embodiment of the present invention; and

FIG. 2 is a circuit view showing one example of a conventional feeding device.

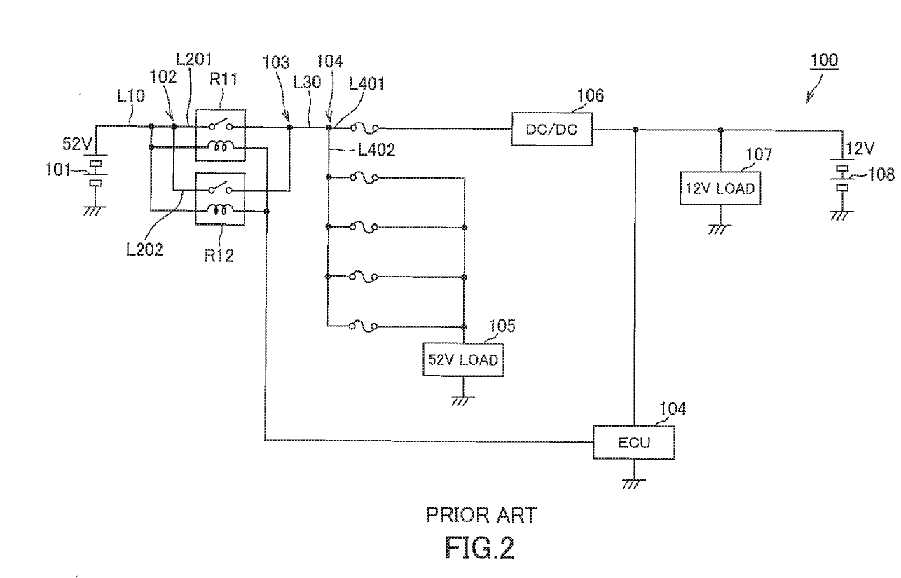

### DESCRIPTION OF THE PREFERRED EMBODIMENT

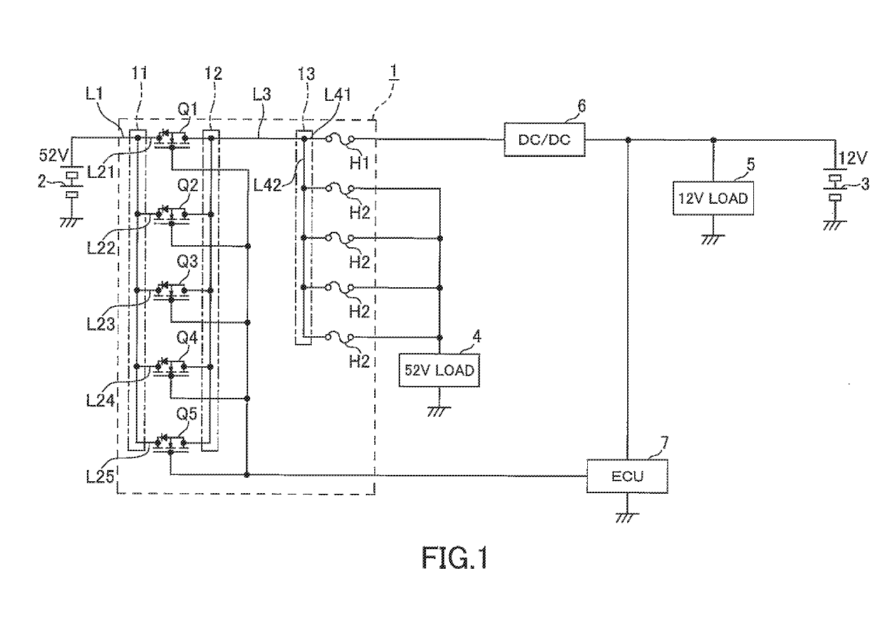

Hereafter, a power-supply box feeding device, electric junction box) of the present invention will be explained with reference to FIG. 1. The power-supply box 1 of the present invention is connected to a battery which is mounted on a vehicle and a load, and is constructed to supply a power source from the battery to the load.

In the vehicle on which the power-supply box 1 of one embodiment of the present invention is mounted, two batteries of 52V-battery 2 (power source) and 12V-battery 3 are mounted, and 52V-load 4 (load) which is driven by 52V and 12V-load 5 which is driven by 12V (load) are arranged.

As shown in FIG. 1, the power-supply box 1 has a branch circuit 11, a merge circuit, a branch circuit 13, MOSFETs Q1-Q5 (switching unit), and fuses H1, H2.

The branch circuit 11 is a circuit for branching a supply route L1 of the 52V-battey 2 into five (=n) branch routes L21-L25. The merge circuit 12 is a circuit for joining the five branch routes L21-125 to one supply route L3. The branch circuit 13 is a circuit for branching the supply route L3 into a 52V-load supply route L41 for supplied to the 52V-load 4 and a 12V-load supply route L42 for supplied to the 12V-load 5. Those branch circuit 11, merge circuit 12 and branch circuit 13 are constructed of for example a bus bar.

Also, on the 12V-load supply route L42, a step-down type DC/DC converter 6 is arranged. The step-down type DC/DC converter 6 converts 52V from the 52V-battery 2 into 12V, and supplies 12V to the 12V-load 5, the 12V-battery 3, and an ECU 7.

The MOSFETs Q1-Q5 are respectively arranged on the five branch routes L21-L25 branched by the branch circuit 11, and turn ON/OFF the power supply to the 52V-load 4 and the 12V-load 5. The MOSFETs Q1-Q5 are n-channel type, and connected to the ECU 7. The MOSFETs Q1-Q5 are ON/OFF controlled by the ECU 7.

In the embodiment of the present invention, gates of the MOSFETs Q1-Q5 are connected to each other, and connected together to the ECU 7. Thereby, the MOSFETs Q1-Q5 are collectively ON/OFF controlled by the ECU 7. The ECU 7 is operated after receiving the power supply from the 12V-battery 3. The MOSFETs Q1-Q5 will be described later.

The fuse H1 is arranged on the 52V-load supply route 41, and is a well-known fuse for preventing overcurrent by fusing when overcurrent flows in the 52V-load supply route L41. The fuse H2 is arranged on the 42V-load supply route 42, and is a well-known fuse for preventing overcurrent by fusing when overcurrent flows in the 12V-load supply route L42.

The power-supply box I further has a connector block (not shown) for housing a connecting terminal which is arranged on a bus bar having the branch circuit 12 and the merge circuit 13, a resin storage box (not shown) for housing the above bus bar, the MOSFETs Q1-Q5, the fuses H1, H2 and the like. By connecting a connector, which arranged on one end of a wire harness connected to the 52V-battery 2, the 12V-battery 3, the 52V-load 4, the 12V-load 5, and the ECU7, to the connector block, the 52V-battery 2, the 12V-battery 3, the 52V-load 4, the 12V-load 5 and the power-supply box 1 are able to connected.

Next, the MOSFETs Q1-Q5 will be explained. A rated current of each of the MOSFETs Q1-Q5 is not less than the sum rated current of all loads (12V-battery 3, 12V-load 5, 52V-load 4, and ECU 7) supplied with the power supply from the supply route L3/(5−1) and less than the sum rated current thereof/(5−2).

In other words, when the sum rated current is 120A, the rated current of each of the MOSFETs Q1-Q5 is at least 30A and less than 40A. In the embodiment of the present invention, the rated current of each of the MOSFETs Q1-Q5 is 30A.

According to the power-supply box 1 described above, electrical current supplied from the 52V-battery 2 is branched to each of five branch routes L21-L25, and flows. For example, when 120A flows in the supply route L1, 24A (120/5 A), 24A current flows in each of the five branch routes L21-L25.

At this time, when one of the MOSFETs Q1-Q5 fails, the current supplied from the 52V-battery 2 is branched into the four branch routes L21-L25 excluding the branch routes of a failed MOSFET in the five branch routes L21-L25, and flows in the four branch routes. Current of 30A (120/4) flows in the four branch routes L21-L25 respectively, and the rated current of each of the MOSFETs Q1-Q5 is equal to or lower than 30A. Further, the MOSFETs Q1-Q5 are specified so that 30 A×5=150 A can flow at the sum thereof. For this reason, it is possible to reduce waste comparing with the conventional 120 A×2=240 A.

According to the embodiment described above, the branch circuit 11 branches the supply route L1 of the 12V-battery into the five branch routes L21-L25, and the MOSFETs Q1-Q5 are respectively arranged on the five branch routes L21-L24. The rated current of the MOSFETs Q1-Q5 is equal to or more than the rated current 120 A/4 (30 A) of the 52V-load 4 and the 12V-load 5 which are supplied with electric power from the supply route L3 and less than 120 A/3. Thereby although one of the five MOSFETs Q1-Q5 fails, a power source can be supplied to the 52V-load 4 and the 12V-load 5. Further, redundancy of the power source can be achieved, the rated current of the MOSFETs Q1-Q5 can be reduced, and thereby waste can be reduced.

Further, according to the embodiment described above, since switching unit is configured of the MOSFETs Q1-AQ5, it is possible to decrease size.

Also, according to the embodiment described above, two batteries (power source) of the 52V-battery and the 12V-battery are mounted, but it is not limited thereto. One battery as the power source may be provided.

Furthermore, according to the embodiment described above, the DC/DC convertor 6 is arranged outside of the power-supply box 1, but it is not limited thereto. The DC/DC converter 6 may be arranged inside of the power-supply box 1.

Moreover, according to the embodiment described above, the switching unit is configured of the MOSFETs Q1-Q5, but it is not limited thereto. The switching unit may be configured of a relay in the same manner as conventional.

In addition, according to the embodiment described above, n=5 that the number of branches is branched by the branch circuit 11 is set, but it is not limited thereto, N may be equal to or more than 3, and the branch circuit may be branched into 3 or 4, or more than 6. In this case, the sum rated current of the 52V-load 4 and the 12V-load 5 supplied from the supply route L3 is 120 A, and the rated current of each of the MOSFET may be set to equal to or more than 120 A/(n−1) and less than 120 A/(n−2).

In this regard, when the number of branches is equal to or more than 4 (n≧4), the sum of the rated current is less than two times of the sum rated current 120 A even if the rated current of the MOSFET is set to an upper value (=120 A/(n−2)). Therefore, waste can be reduced than the prior art. When the number of branches is 3 (n=3), the sum of the rated current of the MOSFET is larger than 240 A if the rated current of the MOSFET is near an upper value (=120 A/(3−2)). However if the rated current thereof is near a lower value (=120 A/(3−1)), waste can be reduced. That is, since the number of branches is equal to or more than 3, the sum of the rated current of the MOSFET can be reduced than two times of 120 A.

Further, according to the embodiment described above, the branch circuit 11, the merge circuit 12, and the MOSFETs Q1-Q5 are arranged inside of the power-supply box 1, but it s not limited thereto. A part of them may be arranged outside of the power-supply box 1.

While, in the embodiment, the present invention is described, it is not limited thereto. Various change and modifications can be made with the scope of the present invention.
1 power-supply box (feeding device, electrical junction box)
2 52V-battery (power supply)
3 12V-battery
4 52V-load (load)
5 12V-load (load)
11 branch circuit
12 merge circuit
Q1-Q5 MOSFET (switching unit, semiconductor switch)
L1, L3 supply route
L21-L25 branch route

What is claimed is:

1. A feeding device for supplying electric power to a load comprising:
a branch circuit for branching a supply route of the power into n (n is an integer of 3 or more) branch routes;
a merge circuit for joining the n branch routes to one of the supply route and
a switching unit arranged on the n branch routes respectively,
wherein a rated current of the switching unit is equal to or larger than a rated current of the load divided by n−1 and less than the rated current of the load divided by n−2, the load being supplied with electric power from the supply route.

2. The feeding device according to claim 1, wherein the switching unit is configured of a semiconductor switch.

3. An electric junction box having the feeding device described in claim 1.

4. An electrical junction box having the feeding device described in claim 2.
